(19) United States
(12) Patent Application Publication
(10) Pub. No.: US 2013/0171545 A1
(43) Pub. Date: Jul. 4, 2013

(54) FUEL CELL HAVING MINIMUM INCIDENCE OF LEAKS

(71) Applicant: EnerFuel, Inc., West Palm Beach, FL (US)

(72) Inventors: Daniel Betts, Parkland, FL (US); James Braun, Lake Worth, FL (US); Matthew Graham, West Palm Beach, FL (US); Thomas J. Pavlik, Riviera Beach, FL (US); Marcela Torres, Boca Raton, FL (US); Santiago Bresani, Boca Raton, FL (US)

(73) Assignee: ENERFUEL, INC., West Palm Beach, FL (US)

(21) Appl. No.: 13/724,648

(22) Filed: Dec. 21, 2012

Related U.S. Application Data
(60) Provisional application No. 61/580,703, filed on Dec. 28, 2011.

(51) Int. Cl. H01M 8/02

(52) U.S. Cl. CPC H01M 8/0276; H01M 8/0247
USPC 429/508; 429/507

(57) ABSTRACT

The disclosure relates to an electrochemical assembly and a method of making an electrochemical assembly.

### CROSS REFERENCE TO RELATED APPLICATION

This application claims the benefit of U.S. Provisional Application No. 61/580,703, filed Dec. 28, 2011, which is hereby incorporated by reference in its entirety.

### FIELD OF THE DISCLOSURE

The disclosure relates generally to an electrochemical assembly and a method of making an electrochemical assembly. More particularly, the disclosure relates to fuel cells and flow batteries, and to a method of making fuel cells and flow batteries.

### BACKGROUND OF THE DISCLOSURE

A fuel cell is an electrochemical cell that converts chemical energy from a fuel into electric energy. Electricity is generated from the reaction between a reactant and an oxidizing agent. The reactants flow into the cell, and the reaction products flow out of the cell. A flow battery is a form of rechargeable battery in which an electrolyte flows through the electrochemical cell. Used electrolyte can be recovered and reused. Additional electrolyte can be added to quickly recharge the flow battery.

Fuel cell assemblies comprise a plurality of fuel cells stacked and compressed between end plates and electrically coupled in series to achieve a desired output voltage. The end plates comprise external fluid supply ports through which fuel and oxidants are provided and external fluid discharge ports for discharging reaction products. The end plates also have corresponding internal ports fluidly coupled to ports in each fuel cell to supply fuel thereto and remove reaction products therefrom. The supply and discharge ports of each fuel cell are fluidly coupled to supply and discharge ports of adjacent fuel cells or end plates. The temperature of the reactants and/or the fuel cell assembly may be raised to increase the efficiency of the reaction. The reaction generates heat which is removed from the fuel cell assembly to prevent damage.

Heating and cooling, particularly of high temperature fuel cell assemblies, generate load stresses which can cause crossover and overboard leaks. Crossover leaks cross-contaminate the reactants reducing efficiency or damaging the fuel cells. Overboard leaks also reduce efficiency due to the loss of reactants. Leaks can occur at any fluid interface in the fuel cell assembly such as at the fuel cells, ports and end plates.

Accordingly, there is a need in the art for minimizing the incidence of leaks in fluid interfaces in the fuel cell assembly. It would be further advantageous if thermal control features could be introduced into the assembly to increase the efficiency thereof.

### BRIEF DESCRIPTION OF THE DISCLOSURE

The present disclosure is generally directed to features for inclusion with a fuel cell assembly, and in some particular embodiments, a flow battery, to minimize the incidence of leaks at fluid interfaces. In some embodiments, the features include thermal control features and robust fluid interfaces such as heat transfer members (also referred to herein as fins), cooling ducts and channels, and thermal insulation plates. In various further embodiments according to the disclosure, gasket supports are provided to prevent such leaks.

In one particular embodiment, the present disclosure is directed to a fuel cell assembly comprising: an end plate having a fluid port; a fuel cell; an intermediate plate having an orifice, the intermediate plate positioned between the end plate and the fuel cell; a tubular member disposed through the fluid port of the end plate and at least partially through the orifice of the intermediate plate, the tubular member being fluidly coupled to the fuel cell and fluidly sealed with the orifice so as to prevent fluid communication between a fluid flowing through the tubular member and the end plate; and a flange securing the tubular member to the intermediate plate.

In another embodiment, the present disclosure is directed to a fuel cell assembly comprising: a first end plate; a second end plate; a plurality of fuel cells stacked between the first end plate and the second end plate, each fuel cell having an active area and a seal surface surrounding the active area, at least some of the plurality of fuel cells having heat transfer members extending from the seal surfaces and forming cooling channels with adjacent heat transfer members; a duct cover supported by the first end plate and the second end plate and positioned over the cooling channels formed by the heat transfer members; and a heat transfer layer member in contact with and disposed between the duct cover and the heat transfer members. The heat transfer layer member enhancing heat transfer between the heat transfer members and the duct cover.

In yet another embodiment, the present disclosure is directed to a fuel cell assembly comprising a fuel cell, the fuel cell including a first fuel cell plate; a gasket and a member between the first fuel cell plate and the gasket. The first fuel cell plate including: an active area parallel to the member; a seal surface surrounding the active area; a port positioned such that the seal surface is between the port and the active area; and a flow channel fluidly coupling the port and the active area. The fuel cell further comprises a support element disposed between the first fuel cell plate and the gasket, and over the flow channel, to substantially prevent the gasket from at least partially blocking the flow channel upon application of a compressive force to the fuel cell.

In another embodiment, the present disclosure is directed to a fuel cell assembly comprising a fuel cell. The fuel cell includes a first fuel cell plate including a port, an active area, a seal surface surrounding the active area, and an open flow channel fluidly coupling the port and the active area; a sealing member adjacent to the seal surface and surrounding the active area, the sealing member configured to withstand, without substantially deflecting into the open flow channel, a compressive force applied to seal the fuel cell; and a sealing medium disposed on the sealing member.

In another embodiment, the present disclosure is directed to a fuel cell assembly comprising: a first end plate having an orifice therethrough; a second end plate; a plurality of fuel cells stacked between the first end plate and the second end plate, each fuel cell having an active area; and a busplate having a planar portion substantially coextensive with the active area and a connecting portion adapted to electrically connect the fuel cell assembly to a load. The connecting portion extending from the center of the planar portion and through the orifice in the first end plate such that the planar portion exhibits balanced electrical resistance.

In another embodiment, the present disclosure is directed to a fuel cell assembly comprising an end plate having an orifice therethrough; a fuel cell having an active area; an intermediate plate having an orifice therethrough and a recess; and a busplate residing in the recess. The intermediate plate positioned between the end plate and the fuel cell and positioned such that the recess faces the fuel cell. The busplate has a planar portion substantially coextensive with the active area and a connecting portion adapted to electrically connect the fuel cell assembly to a load. The connecting portion extending from the planar portion and through the orifices in the intermediate plate and the end plate.

In yet another embodiment, the present disclosure is directed to a fuel cell assembly comprising an end plate having an orifice therethrough; a fuel cell having an active area; and a busplate having a planar portion substantially coextensive with the active area and a connecting portion adapted to electrically connect the fuel cell assembly to a load. The connecting portion extending from the planar portion and through the orifices in the end plate.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a plan view of an embodiment of a fuel cell assembly according to the disclosure;

FIG. 2 is a perspective exploded view of another embodiment of a fuel cell assembly according to the disclosure;

FIGS. 3 and 4 are plan sectional views of further embodiments of fuel cell assemblies according to the disclosure showing a fluid fitting;

FIGS. 5 and 6 are perspective sectional and partial views of still further embodiments of fuel cell assemblies according to the disclosure;

FIG. 7 is a plan sectional view of an embodiment of a busplate subassembly according to the disclosure;

FIG. 8 is a perspective view of an embodiment of a thermal insulation plate according to the disclosure;

FIG. 9 is a plan sectional view of an embodiment of a fuel cell subassembly according to the disclosure;

FIG. 10 is a perspective exploded view of an embodiment of a fuel cell subassembly according to the disclosure;

FIG. 11 is an elevation view of an embodiment of a membrane electrode assembly (MEA) according to the disclosure;

FIG. 12 is a plan view of components of the fuel cell assembly depicted in FIG. 1 and the MEA depicted in FIG. 11;

FIG. 13 is plan partial view of the membrane electrode assembly (MEA) depicted in FIGS. 11 and 12;

FIG. 14 is plan view of an embodiment of a bipolar plate and a gasket according to the disclosure;

FIGS. 15-17 are perspective partial and plan sectional views of the bipolar plate and seal of FIG. 14;

FIGS. 18-20 are perspective partial and plan sectional views of another embodiment of a bipolar plate with a supported seal area according to the disclosure;

FIGS. 21-23 are perspective partial views of further embodiments of bipolar plates according to the disclosure; and

FIGS. 24 and 25 are plan and perspective partial views of a yet further embodiment of a bipolar plate and sealing member according to the disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the disclosure, and such exemplifications are not to be construed as limiting the scope of the disclosure in any manner. The transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

### DETAILED DESCRIPTION

For the purposes of promoting an understanding of the principles of the present disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. No limitation of the scope of the disclosure is thereby intended. The present disclosure includes any alterations and further modifications in the illustrated assemblies and described methods and further applications of the principles of the disclosure which would normally occur to one skilled in the art to which the disclosure relates.

The present disclosure relates to electrochemical cells and a method of making electrochemical cells. Exemplary electrochemical cells include fuel cells and flow batteries. A fuel cell comprises an anode, a cathode and an electrolyte therebetween. Exemplary fuel cells include proton exchange membrane, solid oxide and molten carbonate fuel cells. A proton exchange membrane fuel cell comprises two plates with a polymer electrolyte membrane (PEM) between them. A plate of one fuel cell is adjacent a plate of an adjacent fuel cell in the stack. The plates have flow channels through which the reactants and reaction products flow from supply to discharge ports. The flow channels expose the PEM to the fluids to promote the reaction. The PEM is supported by a frame. Gaskets may be provided between the PEM and the plates to seal the fuel cell. If the area of the gasket overlapping the flow channels is unsupported, leaks may occur and/or the gasket may deflect into the channel presenting a blockage.

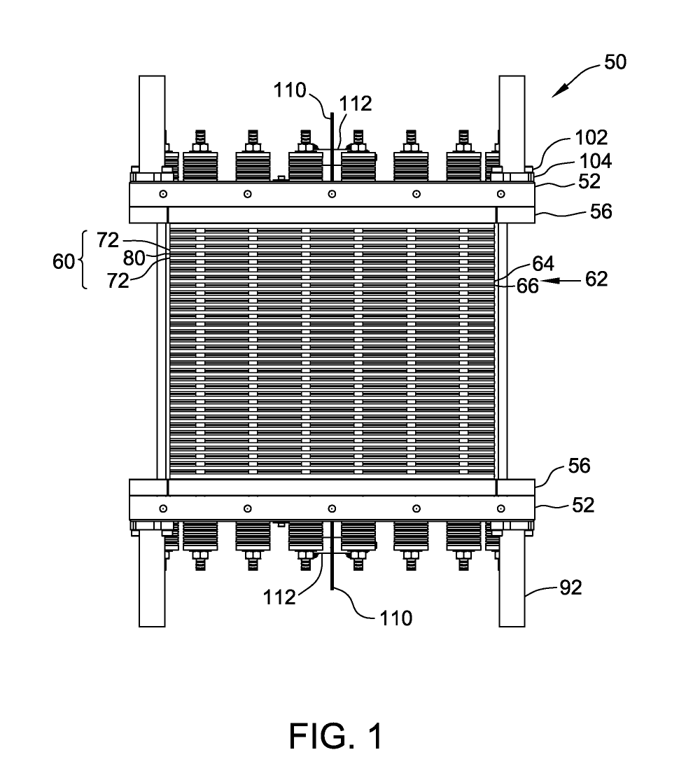

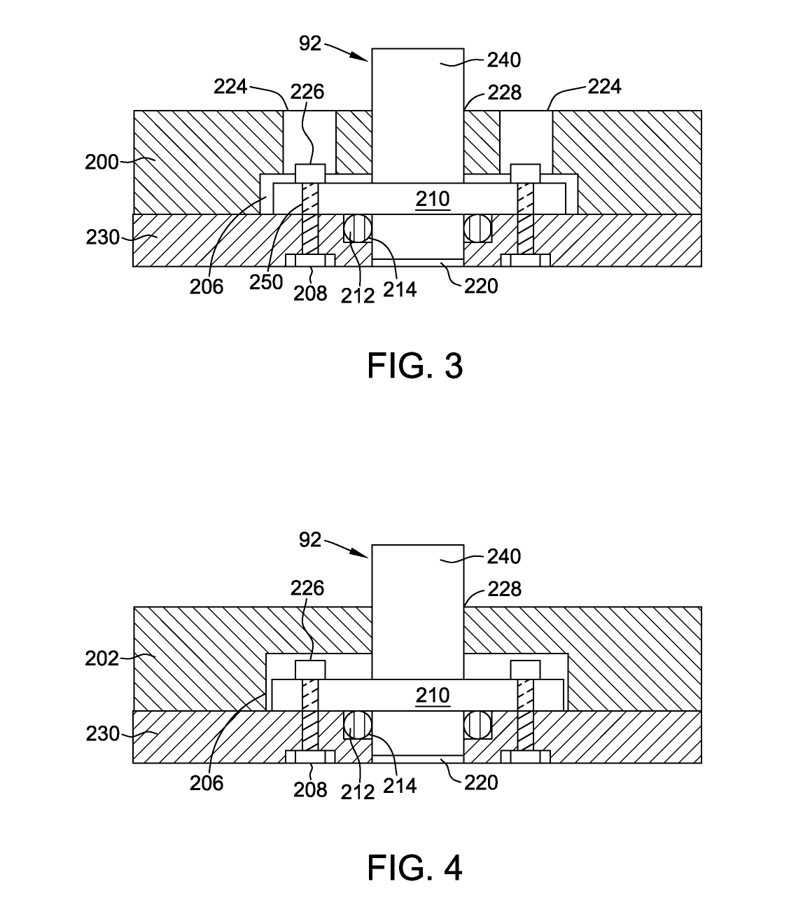

The foregoing embodiments will now be described with reference to the figures. While the embodiments are described with reference to fuel cell assemblies, the embodiments are equally applicable to flow batteries and other electrochemical devices. Referring to FIG. 1, in one embodiment according to the disclosure a fuel cell assembly is provided, denoted by numeral 50. Fuel cell assembly 50 comprises end plates 52 and a plurality of fuel cells 60 compressed therebetween by a plurality of threaded rods 102 and threaded nuts 104. Fluid fitting assemblies 92 are also provided, which supply or discharge fluids to and from the fuel cell assembly. The shown location of threaded rods 102 and fluid fitting assemblies 92 is illustrative only. Threaded rods 102 and fluid fitting assemblies 92 can be positioned in any location, based on the design of the fuel cells, permitting proper compression of the fuel cells. A fluid fitting assembly 92 is described in further detail with reference to FIGS. 3-5. In another embodiment, fluid fitting assemblies 92 are substituted with any known fluid fitting.

Fuel cell 60 includes a membrane electrode assembly (MEA) 80, two gaskets 72 adjacent MEA 80 and two plates 62 adjacent gaskets 72. Gaskets 72 are provided to constrain the oxidant, such as air, on one side of the MEA and a fuel gas, such as hydrogen, on the opposite face of the MEA and to prevent crossover and overboard leaks. In one example, gaskets 72 also serve as spacers to precisely control compression of the MEA active area.

In the present embodiment, plate 62 comprises a body portion 66 and a heat transfer member 64 surrounding body portion 66. Heat transfer member 64 transfers heat to and from body portion 66 and may be referred to herein as a fin. In a form thereof, plates 62 do not include fins. In a further form thereof, fuel cell plates with and without fins are intermixed to optimize air flow through cooling ducts or channels formed between the fins. In one example, the fuel cell plates are rectangular and fins extend from the long side of the fuel cell plates.

In the present embodiment, thermal insulation plates 56 are provided which are described below at least with reference to FIGS. 3, 4, 6, 8 and 9. In other embodiments, thermal insulation plates 56 are omitted.

A fuel cell assembly also comprises electrical connectors to supply electrical energy to a load. In the present embodiment, electrical connectors, illustratively busplates 110, are shown approximately centered on end plates 52. Busplates 110 are electrically coupled to fuel cells 60. Electrical insulators 112 surround busplates 110 to prevent electrical contact with end plates 52. In other embodiments, electrical connectors are not approximately centered on end plates 52. In one example, electrical connectors are provided at the periphery of the end plates.

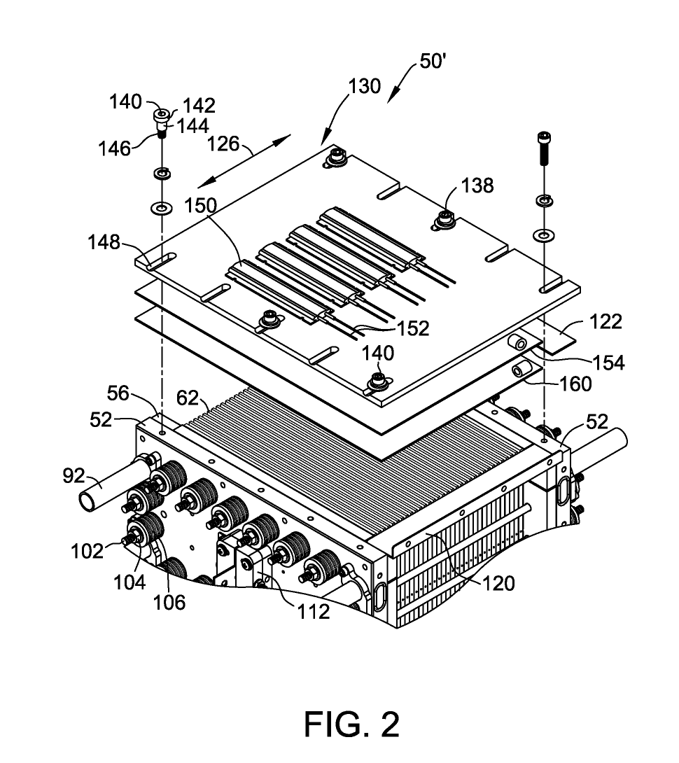

Referring to FIG. 2, a perspective view of another embodiment of a fuel cell assembly is provided, denoted by numeral 50′. Fuel cell assembly 50′ is similar to fuel cell assembly 50 and further comprises a duct cover 130 which is secured to one end plate 52 at one end and is slidingly coupled to the opposite end plate 52 to allow fuel cell assembly 50′ to expand and contract without being constrained by duct cover 130. A plurality of springs 106 are shown between end plates 52 and corresponding threaded nuts 104 to permit thermal expansion while keeping forces within a desired range. Duct cover 130 is secured with bolts 138 at one end and fastening members 140 at the opposite end. Fastening members 140 are introduced into slots 148 in duct cover 130 and secured to end plate 52. Each fastening member 140 includes a shoulder portion 144 between a head portion 142 and a threaded portion 146. Shoulder portion 144 allows slot 148 to slide along the direction of arrow 126. In a variation thereof, a duct cover comprises a two piece design, each piece being fixedly mounted to each end plate. A sliding bridge member receives the unattached ends of the two duct cover pieces to enable one or both of the pieces to slide in the bridge member. In one example, the bridge member comprises an H-shaped profile, the top and bottom of the H representing elongate channels for receiving the unattached ends of the two duct cover pieces.

Plates 62 are finned to enable airflow passing between the fins to cool fuel cell assembly 50′. Duct cover 130 together with frame members 120 form a duct aligned with plates 62. As shown, duct cover 130 also supports a plurality of electric heaters 150 provided to heat the fuel cells through the fins. A pair of electrical connectors 152 powers each electric heater 150 when it is desired to raise the temperature. To reduce thermal resistance between the tips of the fins and duct cover 130, a compliant heat transfer layer member 154 is introduced therebetween. Further, a protective layer member 160 is provided between heat transfer layer member 154 and the fins to protect heat transfer layer member 154 from abrasion, raking and spalling caused by the fins when the fuel cell assembly thermally expands and contracts. Heat transfer layer member 154 is pressed between duct cover 130 and the fin tips sufficiently to establish an adequate heat transfer path. Protective layer member 160 allows the fin tips to slide without damaging heat transfer layer member 154. Exemplary protective layer members 160 include polymeric sheets, such as sheets of polyimide, polyetheretherketone (PEEK), polysulfone, perfluoroalkoxy (PFA), polytetrafluoroethylene (PTFE), fluorinated ethylene propylene (FEP), poly(p-phenylene sulfide) (PPS), and combinations thereof. Shims 122 ensure proper spacing and compression between the fins and duct cover 130.

Thermal expansion and contraction can create leaks in any fluid interface area such as, for example, end plate ports. Other fluid interfaces include, for example, between the bipolar plate and the MEA; between the faces of multi-layered bipolar plates; between the endplate and the first plate (e.g., insulator plate or a reactant distribution plate such as a bipolar plate) present inside the end plate.

Referring to FIGS. 3 and 4, plan sectional views are provided therein of further embodiments according to the disclosure comprising a fluid fitting assembly (exemplary assembly indicated in FIGS. 3 and 4 at 92) mounted to and sealed with an intermediate element. One exemplary intermediate element is the thermal insulation plate 230. Among other benefits, mounting the fluid fitting assembly to the intermediate element decreases the likelihood of overboard leaks and substantially prevents end plate wetting caused by movement of the end plate relative to the intermediate member as it thermally expands and compresses, which would compromise the seal if the fitting were mounted to the end plate. More particularly, by sealing to the insulator plate, reactants and products are prevented from coming into contact with the end plate. This allows for greater choices for the material of the end plate as it need not be especially corrosion resistant. If the fluids do contact the end plate, the end plate must be a material which will not shed ions into the fluid stream. Further, the end plate must be of adequate stiffness at operating temperatures. Typically, metal end plates may be employed. In one particular embodiment, however, high temperature polymers are employed as the end plate since the polymers are capable of routing fluids without shedding ions, thereby minimizing destruction to the fuel cell membranes and reacting with the products and the reactants.

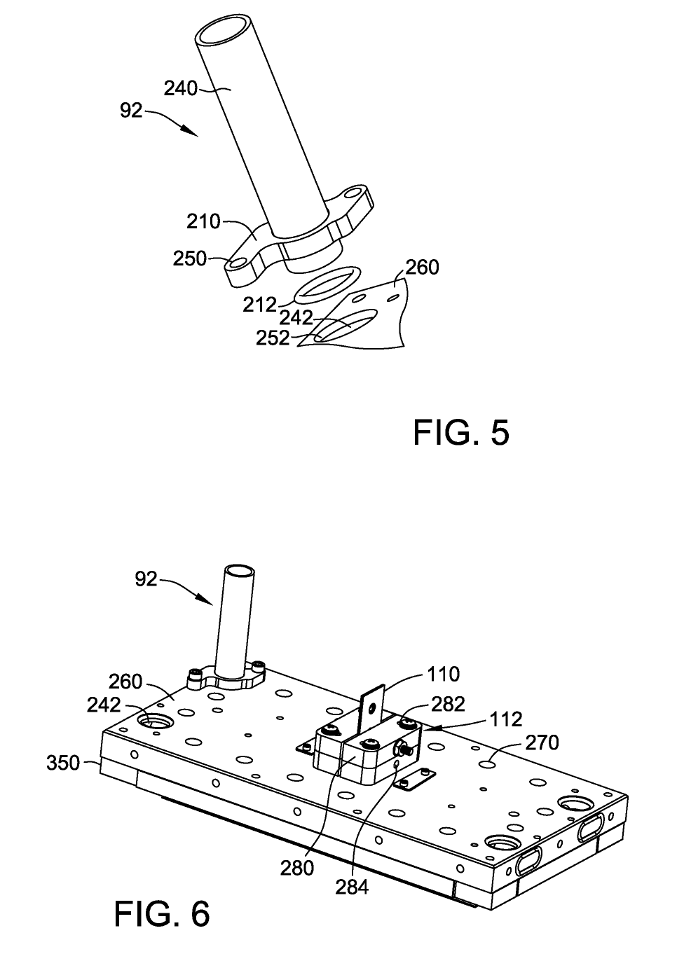

An exemplary low thermal mass fluid fitting assembly 92 is shown having a tubular member 240 with a portion on one side of a flange 210 and another portion on the other side of flange 210. Tubular member 240 is affixed to flange 210. In a variation thereof, tubular member 240 and flange 210 comprise a single piece construction. Flange 210 includes orifices 250 configured to secure flange 210 to the fuel cell assembly. In one example shown in FIGS. 5 and 6, fluid fitting assembly 92 is secured to end plate 260. In the present embodiment, fluid fitting assembly 92 is secured to a thermal insulation plate 230 with fastening members 208 and 226. Exemplary fastening members include bolts and nuts. Thus, tubular member 240 passes through an orifice 228 in end plate 200 (FIG. 3) or end plate 202 (FIG. 4), preventing wetting. Concerns over material shedding into the ports or flow channels are thus alleviated. Thermal insulation plate 230 reduces heat transfer between the fuel cells and the end plates to minimize the impact of thermal expansion on fluid interfaces. An O-ring 212 is placed around tubular portion 240 between flange 210 and a fluid port 220 which is in fluid communication with supply or discharge ports of the fuel cells. When tubular portion 240 is inserted through O-ring 212 into a relief 214, a fluid seal is formed which prevents fluids from flowing out of the fuel cell assembly except through tubular portion 240. In one form thereof, end plate 200 and fluid fitting assembly 92 comprise a corrosion resistant material. An exemplary corrosion resistant material is 316 stainless steel. In the present embodiment, end plate 200 has an opening 206 for receiving flange 210 and orifice 228 for receiving tubular member 240. Flange 210 may be secured to thermal insulation plate 230 before assembly of end plate 200. Alternatively, openings 224 provide access to fastening members 226 so that flange 210 can be secured after end plate 200 is assembled with thermal insulation plate 230. Referring to FIG. 4, end plate 202 differs from end plate 200 in that it does not include openings 224. Consequently, fluid fitting assembly 92 is secured to thermal insulation plate 230 before end plate 202 is assembled such that it covers flange 210. In the present embodiment, tubular members 240 and orifices 228 are circular. In another form thereof, tubular member 240 and orifice 228 comprise non-circular shapes. Exemplary non-circular shapes include square, rectangular and oval shapes.

Referring to FIG. 5, a perspective view of fluid fitting assembly 92 is shown therein. Also shown is a portion of an end plate 260 comprising a port 242 having a relief 252. O-ring 212 is positioned in relief 252 and tubular portion 240 is inserted into port 242. An assembled combination of end plate 260 and fluid fitting assembly 92 is shown in FIG. 6.

Referring now to FIG. 6, end plate 260 is shown adjacent a thermal insulation plate 350. Busplate 110 and electrical insulator 112 are supported by end plate 260. Holes 270 are arranged at the periphery of end plate 260 and provided to receive threaded rods (not shown) and secure the fuel cell assembly. As shown, electrical insulator 112 comprises a plurality of blocks 280, each block 280 including a through-hole 284 through which a fastening member is inserted to secure busplate 110 and a through-hole 282 to secure block 280 to end plate 260. In another variation, electrical insulator 112 comprises a single piece with a slot to receive busplate 110 therethrough.

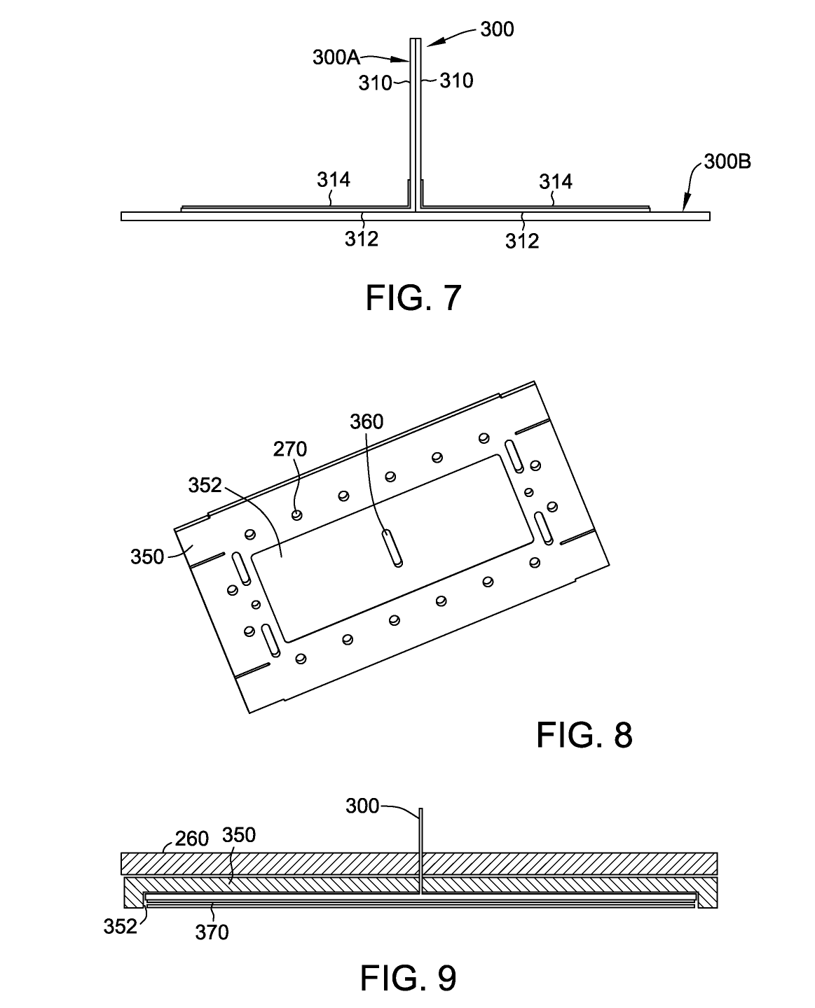

Referring to FIG. 7, a plan sectional view of a busplate 300 is provided. In the present embodiment, busplate 300 comprises two L shaped members, illustratively tabs 310, each having a first portion 300A and a second portion 300B. Tabs 310 comprise a connecting portion 300A of busplate 300. In one example, each tab 310 is made by bending a conductive material member at a right angle. Exemplary conductive materials include copper and aluminum. In one example, tabs 310 are laminated with a dielectric layer 314 to electrically insulate tabs 310 and prevent electrical contact between tabs 310 and end plate. When the first portions are placed adjacent to each other, the second portions form a surface 312. Surface 312 is in electrical contact with the first and last cells on the stack. This may be accomplished by first bonding with an electrically conductive adhesive to an electrically conductive planar portion 300B. Inside the fuel cell assembly, planar portion 300B is electrically coupled to the fuel cells to harvest electrons and to distribute these to connecting portion 300A which extends through an aperture in end plate 260 as described with reference to FIGS. 8 and 9. Surface 312 is in electrical contact with the fuel cells at the opposite ends of the stack. This electrical contact may be achieved by bonding with an electrically conductive adhesive to the first and last bipolar plates in the stack or by bonding to a conductive intermediary plate, which may be placed in intimate contact with the first and last fuel cells in the stack. In another example, surface 312 is placed into electrical contact with elastic, electrically conductive planar members 370. An example of an elastic, electrically conductive planar member is a carbon fiber paper such as SGL GDL 24. Another example of a suitable carbon fiber paper is Spectracorp 2050-C. In another example, the busplate is machined from stock in a single piece construction. In a further example, the busplate is not insulated.

Referring to FIG. 8, a perspective view of thermal insulator plate 350 is provided. FIG. 9 is a plan sectional view of a section of a fuel cell assembly comprising end plate 260, thermal insulation plate 350 and busplate 300. Busplate 300 extends substantially entirely within a pocket 352 formed in thermal insulation plate 350. Without thermal insulation, end plate 260 can create a temperature gradient between the fuel cells located in the middle of the stack and those adjacent the ends of the fuel cell stack.

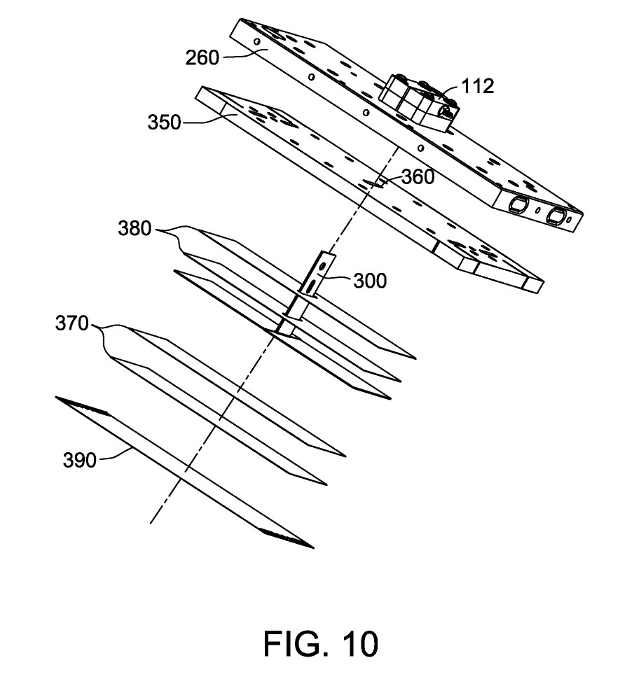

As shown in FIG. 8, a port 360 is provided in thermal insulation plate 350 to receive busplate 300 therethrough. Port 360 coincides with a port in end plate 260 provided for the same purpose. As assembled, busplate 300 is positioned in pocket (also referred to herein as recess) 352 adjacent the inside face of thermal insulation plate 350 rather than the inside face of end plate 260. Busplate 300 thus protrudes through both thermal insulation plate 350 and end plate 260 as shown in FIG. 9. In a variation of the present embodiment, thermal insulation plate 350 is omitted. In one example, pocket 352 is provided in a terminal plate facing end plate 260. In another example, pocket 352 is provided in the internal surface of end plate 260. In a further example, one or more shims 370 are provided to fill pocket 352 and match the depth of pocket 352 to the thickness of the components placed therein to ensure good electrical contact with a terminal plate 390 (shown in FIG. 10). The foregoing examples are not mutually exclusive. Exemplary shims include conductive elastic layers, carbon fiber layers and other compressible layers. The thickness of the components does not exceed the depth of the pocket, otherwise sealing of the pocket with terminal plate 390 would be compromised; that is, in some embodiments, the pocket is deeper than the thickness of the busplate. Among others, one advantage of elastic and compressible shims is that they can be stacked to overfill the unfilled depth of the pocket to provide both electrical contact and mechanical support to the fuel cell assembly. When the assembly is compressed, the shims compress to the precise previously unfilled depth of the pocket.

The busplate may reside in a frame which surrounds the perimeter of the busplate in a similar manner to that of the pocket/recess. The frame may be of a single layer or of multiple laminations. The frame may be constructed from an electrically insulative material which is compatible with the temperature of the fuel cell in operation and able to withstand the mechanical load placed upon it. Examples of suitable materials from which the frame may be constructed include polymers such as polyimide, tetrafluoroethylene (TFE), perfluoroalkoxy copolymer (PFA), polysulfone, and epoxy, as well as fiber reinforced composites making use of these polymers.

Referring to FIG. 10, an exploded perspective view of a further embodiment of a section of a fuel cell assembly according to the disclosure is provided. The assembly includes end plate 260, thermal insulation plate 350 and busplate 300. The assembly further comprises shims 370, terminal plate 390 and two additional shims 380 positioned between thermal insulation plate 350 and busplate 300. Exemplary shims 380 comprise double-sided adhesive tape configured to unitize busplate 300 to thermal insulation plate 350 so that the two components, once unitized, form a subassembly that can be inverted for placement onto the top of the fuel cell stack. The subassembly components are shown in the inverted orientation.

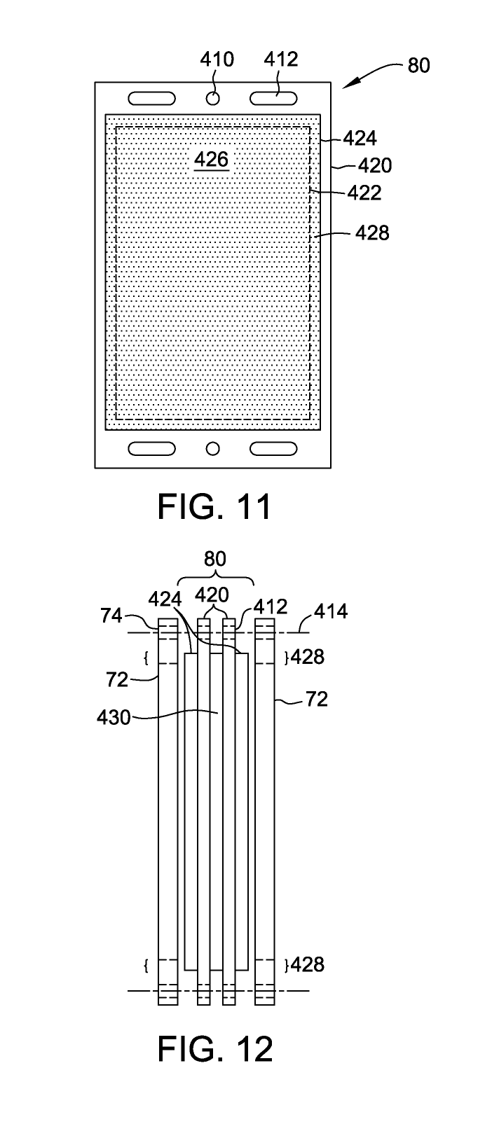

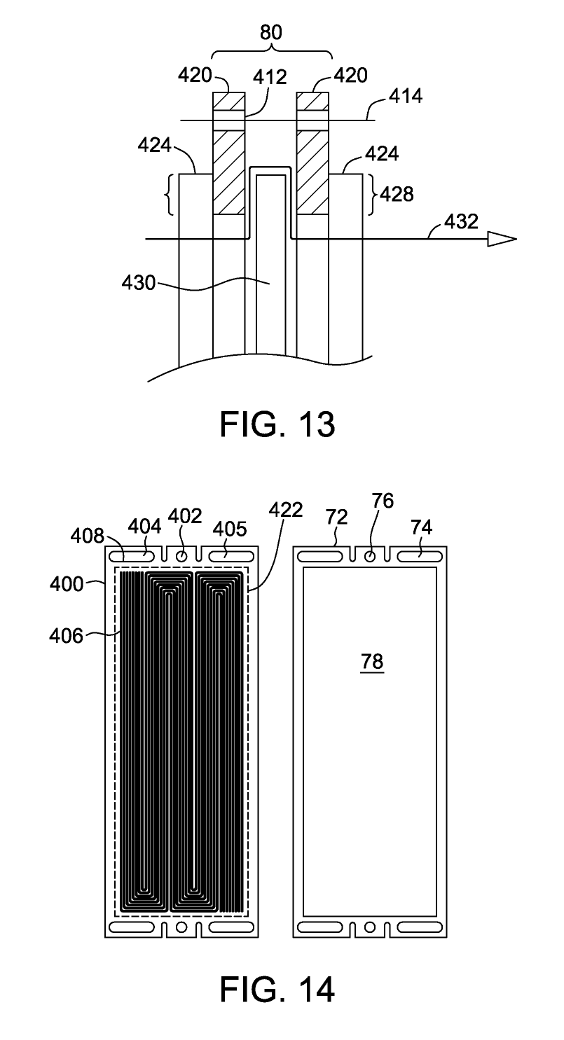

Referring to FIGS. 11 and 12, an elevation and a plan side view of an embodiment of MEA 80 according to the disclosure is provided therein. The thicknesses of the MEA components are exaggerated relative to the thickness of the bipolar plate shown in FIG. 14 to illustrate the order of their assembly and highlight potential leak paths. FIG. 11 shows a frame 420 with a pair of holes 410 therein for receiving alignment rods therethrough. Also shown are a plurality of openings 412 which form part of supply and discharge fluid pathways and are fluidly coupled to ports (e.g., shown in FIG. 6 at 242) when the fuel cells are stacked. Frame 420 has an opening 422 overlayed by a gas diffusion layer 424. A second frame 420 and a second gas diffusion layer 424 are shown in FIG. 12. A membrane 430 is disposed between frames 420 (shown in FIG. 12). An MEA seal area 428 is defined by the surface areas between the edges of opening 422 and gas diffusion layer 424. The widthwise extent of the MEA seal area 428 is illustrated by opposing brackets in FIGS. 12 and 13. Appropriate compression of MEA seal area 428 is necessary to prevent leaks. An active area 426 of MEA 80 is substantially coterminous with opening 422. While a five layer MEA has been shown and described, the embodiments disclosed herein are not so limited. Particularly, the assembly may include less than 5 MEA layers, such as 1 layer, 2 layers, three layers, four layers, or more than 5 MEA layers, such as 6 layers, 7 layers, 8 layers, 9 layers, 10 layers or more, without departing from the present disclosure.

Also shown in FIG. 12 is a pair of gaskets 72 having orifices 74 which form part of the fluid pathways and orifices 76 (shown in FIG. 14) adapted to receive alignment rods therethrough. A centerline 414 is shown to indicate the alignment of openings 412 with orifices 74.

Referring now to FIG. 13, a potential seal area leak pathway, between frames 420 and around membrane 430, is indicated by arrow 432.

FIG. 14 is a plan view of an embodiment of a bipolar plate and a gasket according to the disclosure. The bipolar plate, denoted by numeral 400, comprises fluid ports 404 and 405, orifices 402, flow channels 406 and slot ports 408. Flow channels 406 define fluid pathways beginning and ending with slot ports 408 through which fluids are supplied and/or discharged at either end of the pathways to fluid ports 404. Gasket 72 comprises orifices 74, orifices 76, and an opening 78 which is sized substantially the same as opening 422 of frame 420. As shown in FIG. 12, gaskets 72 are placed on the sides of MEA 80. Bipolar plates 400 are placed adjacent gaskets 72. Flow channels 406 are provided on both sides of bipolar plate 400. Flow channels 406 are also provided on monopolar plates which are like bipolar plates except that, since they are placed at the ends of the fuel cell stack, only comprise flow channels on the side facing the center of the stack. Bipolar plates 400 are similar to bipolar plates 62 of FIG. 1 except for the omission of fins. The serpentine pattern of flow channels 406 is illustrative. In another form thereof, other patterns are provided, non-limiting examples of which include rectangular, and linear lines that extend diagonally (i.e., at angles relative to the longitudinal and lateral axes of the bipolar plate 400). The flow channels on the opposing faces of the bipolar plate are configured to distribute fluids evenly across gas distribution layers 424 and membrane 430. In one example, only one flow channel is provided, however, it should be understood that more than one flow channel may be provided without departing from the present disclosure.

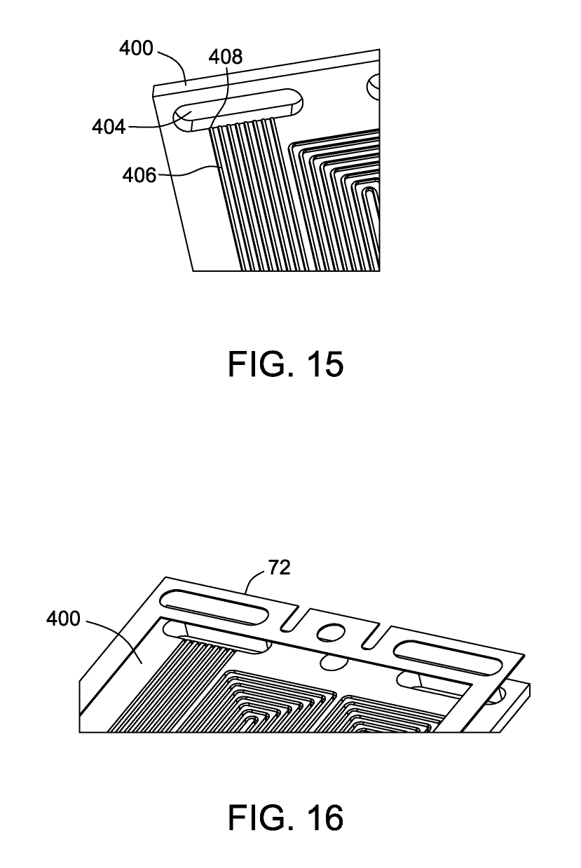

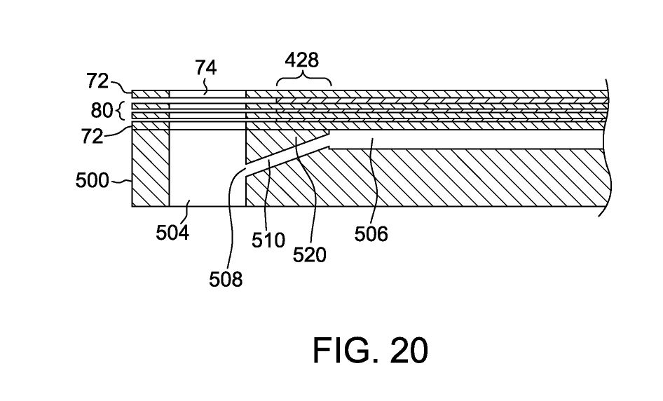

An area of the bipolar plate corresponding substantially to the opening of the frame is referred to as the active area. The active area is surrounded by a seal surface. The seal surface at least overlaps the MEA seal area. In one embodiment, although not shown, the seal surface is larger than the MEA seal area. The flow channels fluidly couple the supply and discharge ports of the fuel cell plate. The flow channels extend over the active area of the fuel cell and are open in the active area. In one embodiment, as shown in FIGS. 15 and 16, channels 406 extend into the slotted supply port 404 and are open to the plate's surface 400 just as the entire flowfield is open to the plate's surface 400. In FIG. 20, however, the ports 504 are angled so that they dive beneath the plate's surface 500. Accordingly, the ports 504 of this alternative embodiment are not open to the plate's surface 500 in the seal area 428 of the MEA 80. This configuration prevents the seal from extruding into the channels, thereby blocking them.

When the fuel cell assembly is compressed, bipolar plates compress the seal surface and the MEA seal areas. If the gaskets are compliant, the compression force can cause the gaskets to deform into the open flow channels which will partially or completely block the flow of fluids. Furthermore, the gaskets are not fully compressed in the areas overlapping the open flow channels, which can potentially result in leaks. Additional embodiments of sealing features according to the disclosure are disclosed below with reference to FIGS. 15-25 which are configured to reduce the incidence of leaks in fuel cell assemblies. Additional embodiments according to the disclosure comprise combinations of the features of embodiments described above and below.

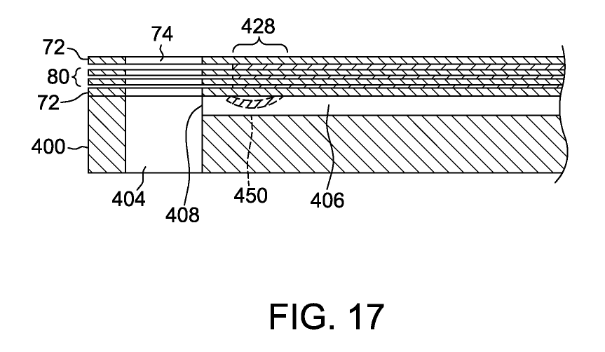

FIGS. 15-17 are perspective partial and plan sectional views of bipolar plate 400. As illustrated therein, flow channels 406 are entirely open. As shown in FIG. 17, bipolar plate 400 is overlaid by gaskets 72 and MEA 80. A bracket denotes seal area 428. A deformed portion 450 of gasket 72 is shown in phantom to illustrate the negative impact of compression on an unsupported gasket under seal area 428. Port 404 may be referred to hereafter as a “slotted port” due to the presence of slot ports 408, corresponding to open portions of channels 406, on one of its surfaces. In one example, open flow channels are machined on a blank plate. In another example, open flow channels are produced by molding techniques.

As described above, reactants and oxidant enter the fuel cell flow channels through the plate ports, travel through the flow channels and exit through the plate ports at the opposite end of the fuel cell flow channels. Clamping pressure is applied to the MEA seal area to seal the membrane between the frames. In the embodiments described above with reference to FIGS. 11-17, the flow channels do not support the MEA seal area so sealing gaskets can deform into fluid flow channels upon the application of clamping pressure, particularly when thick compliant sealing gaskets are used.

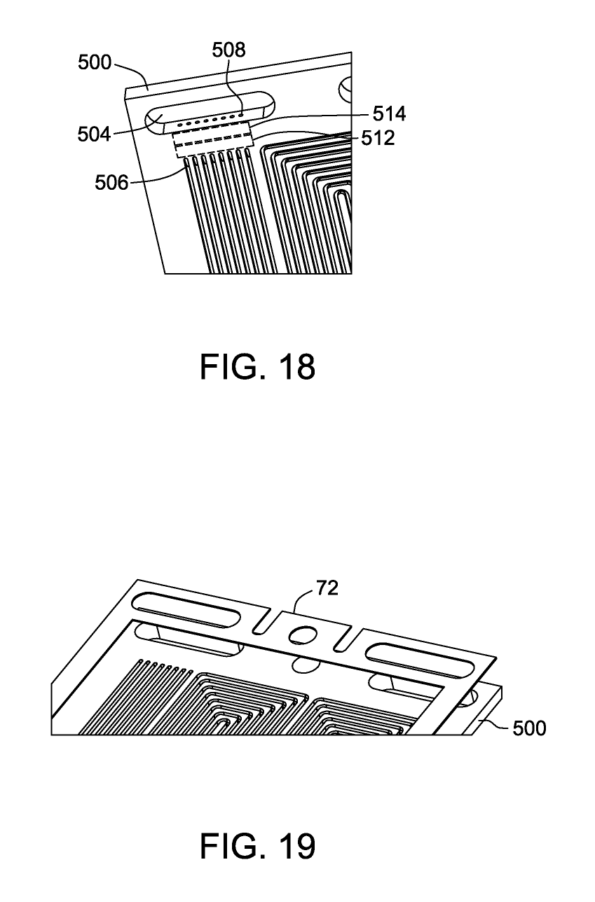

Referring now to FIGS. 18-20, perspective partial and plan sectional views of an embodiment of a bipolar plate with supported MEA seal areas according to the disclosure are provided. An exemplary bipolar plate 500 is shown therein having flow channels 506 on at least one surface including closed portions formed by elongate angled holes 510 which fluidly couple open portions of flow channels 506 with openings 508 located on a face of plate port 504. A section 520 (shown in FIG. 20) intermediate angled holes 510 and the seal surface supports the MEA seal areas. A supported MEA seal area is represented in phantom by rectangle 514 in FIG. 18. As shown, the seal surface includes the areas represented in phantom by rectangles 512 and 514 to illustrate that, in the present embodiment, the seal surface is larger than the MEA seal area. In one example, angled holes are provided by layering and stacking several thin layers, each layer having a pattern therein which, when combined with the patterns in the other layers, forms a three-dimensional pattern. To form an angled hole, oval openings in each layer are offset from each other so that when the layers are stacked, an elongate opening is formed. In another example, angled holes are drilled. Exemplary drilling techniques include mechanical, water jet and laser drilling.

In additional embodiments according to the disclosure, bridge plates are provided to support seal regions and/or the MEA seal area and enhance sealing of the fuel cell. A bridge plate which spans the flow channels closes the portion of the flow channels under the MEA seal area to support the MEA seal area. Reactant flows under the bridge plate through the flow channels and, after bathing the gas diffusion layer, flows out of the flow cell. Bridge plates are configured to support the gasket without excessive deflection or substantial deformation and are made from materials compatible with the electrical, chemical and thermal environment of the fuel cell. Compatible materials for the bridge plates include, for example, corrosion resistant metals such as tantalum, niobium, Hasteloy® (available from Haynes International, Inc. (Kokomo, Ind.)), Inconel® (available from Special Metals Corporation (New Hartford, N.Y.)), and combinations thereof. Additional compatible materials include graphite composition material, polymers (e.g., PEEK, polysulfone), and mineral-based material such as mica. In one variation thereof, a recess is provided to receive the bridge plate. In one example, the bridge plate is thicker than the depth of the recess so as to enhance clamping pressure and ensure good sealing contact is always achieved in the MEA seal area. In another example, the bridge plate is provided but the recess is omitted. In a further example, separate and independent bridge plates are provided for the seal region exclusive of the MEA seal area and for the MEA seal area. Recesses can be machined before or after flow channels are machined and can also be formed at the time the flow channels are molded. In one example, the bridge plate is inserted in the recess and secured by an interference fit. In another example, the bridge plate is bonded with adhesives to the bipolar plate or to the gasket. In another aspect, a relatively thick and compliant gasket is provided to compensate for variation due to manufacturing tolerances and other causes of variation.

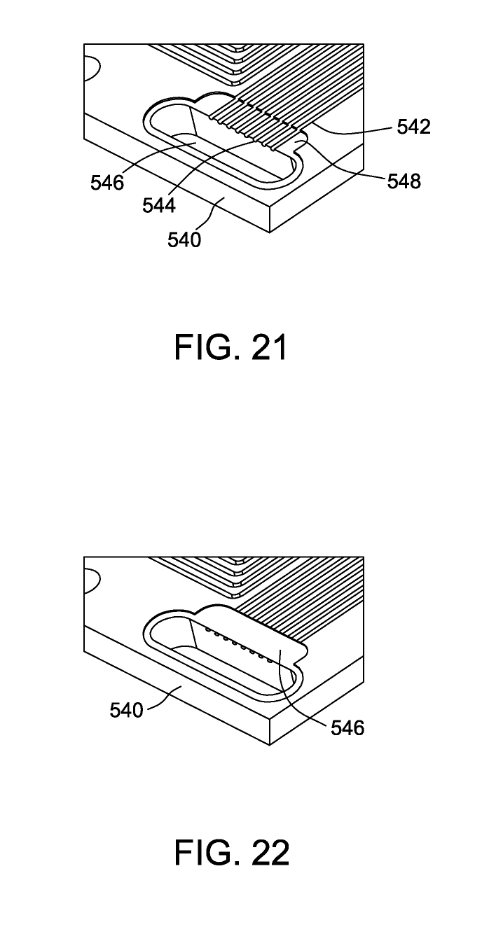

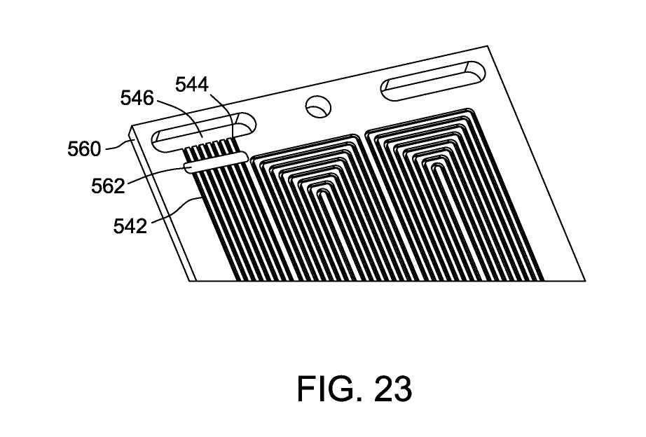

Referring now to FIGS. 21-23, perspective partial views of embodiments of bipolar plates with bridge plates according to the disclosure are provided. Exemplary bipolar plates 540 and 560 are shown in FIGS. 21-23 having flow channels 542 ending at flow channel ports 544 on a surface of bipolar plate port 546. In FIGS. 21 and 22, a recess 548 is provided which receives a bridge plate 546 (shown in FIG. 22). In the present embodiment, recess 548 and bridge plate 546 extend to cover the MEA seal area so that clamping pressure applied to seal the fuel cell does not deform the gasket. In FIG. 23, a bridge plate 562 is provided in a recess in bipolar plate 560 which bridges over flow channels 542 at the MEA seal area only.

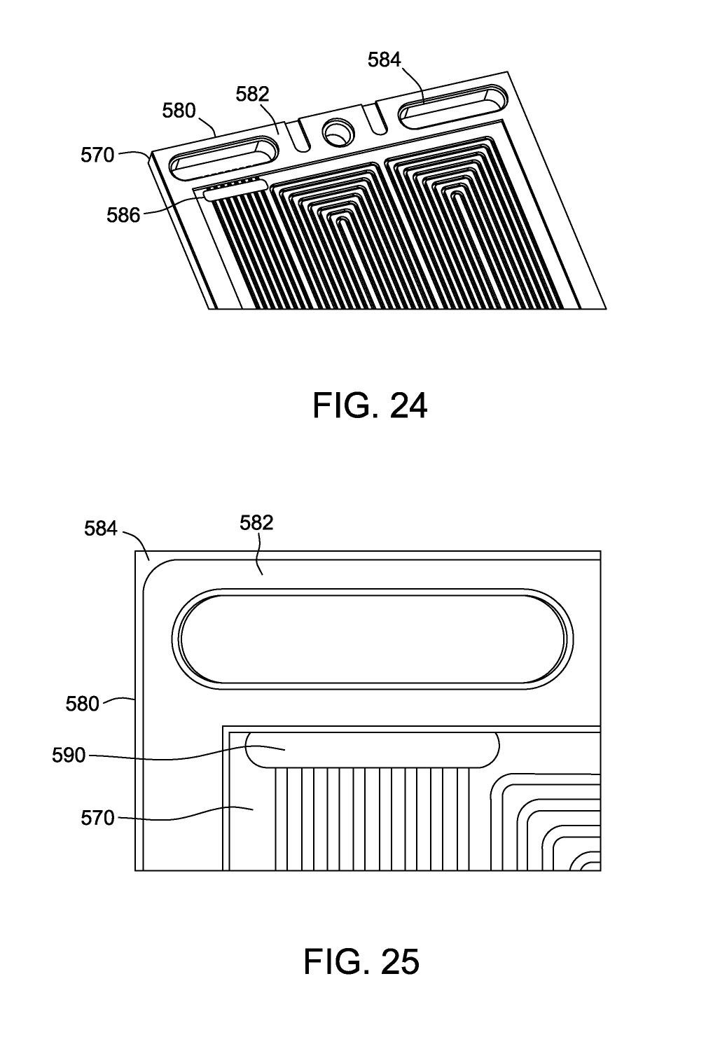

Referring now to FIGS. 24 and 25, perspective and plan partial views of further embodiments of bipolar plates with enhanced fluid interference control features according to the disclosure are provided. A bipolar plate 570 is shown therein covered by a sealing member 580 having a sealing medium 582 thereon. A sealing medium relief 584 is also shown which reduces the likelihood of sealing medium 582 flowing into the ports or impinging on MEA structures upon application of clamping pressure. In another example, the sealing medium relief is omitted. Sealing member 580 is sufficiently stiff to be self-supporting. In one example, sealing member 580 is fabricated from metal. In another aspect, sealing member 580 comprises a corrosion resistant material. Exemplary corrosion resistant materials include stainless steel and polymers (e.g., fiber reinforced polymers such as fiber-reinforced PEEK, fiber-reinforced polysulfone, and fiber reinforced phenolic polymers). In a further aspect, a structure with a thin sealing member and a thin sealing medium thereon is produced with tight tolerances and the overall thickness of the fuel cell is reduced as compared with fuel cells implementing thicker compliant gaskets. These advantages are possible in part because thin sealing members can be produced with narrow tolerances. Also, thin coatings of sealing medium can also be applied with narrow tolerances. Furthermore, a thin sealing medium compresses less than a thick compliant gasket; therefore, more precise spacing of the MEA is achieved. A separate bridge plate 586 is provided in the embodiment shown in FIG. 24 to cover the MEA seal area. In one example, sealing member 580 and bridge plate 586 have a generally equal thickness. In a variation thereof shown in FIG. 25, a bridge plate 590 is attached to sealing member 580 which facilitates assembly of the fuel cell. In one example, sealing member 580 and bridge plate 590 are simultaneously die-cut from a blank plate. In another aspect, sealing medium 582 extends over bridge plate 590.

Exemplary sealing media include elastomers (e.g., Viton® fluoroelastomer (available from DuPont, Wilmington, Del.), Kalrez® perfluoroelastomer (available from DuPont, Wilmington, Del.), and silicone) and grease. In one example, sealing medium is sprayed or otherwise deposited on the sealing member. In one aspect, the sealing medium is applied in a pattern. In a variation thereof, a seal groove or channel is provided and the sealing medium is applied in the groove in the form of a bead so that substantially only the sealing member, and not the sealing medium, influences fuel cell spacing, thus the bead seal functions as an O-ring. In another aspect, sealing medium is applied on both sides of the sealing member. In yet another aspect, sealing surfaces, such as the surface of the bipolar plate and the surface of the sealing member, are provided with mating features and sealing medium is applied between the mating features. Exemplary mating features include channels and protrusions. Exemplary protrusions include ribs. In a further example, sealing medium is omitted and sealing is provided by the mating features under pressure. The above-mentioned examples and aspects may also be combined so that, for instance, sealing medium is deposited or sprayed in a pattern, between mating features, or in a groove.

In a further embodiment according to the disclosure, a sealing medium is disposed at a fluid interface to form or enhance a seal. Exemplary fluid interfaces include end plate ports, bipolar plate ports, bipolar plate layers and bipolar plate/gasket surfaces.

In yet another embodiment, the sealing medium is applied to form a conductive seal. In one example, a conductive seal is formed in a laminated multilayered fuel cell plate to establish conductive paths between the laminate layers. Conductive seals may be formed in other areas, in connection with electrical terminals, busplates and end plates, for example. In one variation thereof, a non-conductive sealing medium is used to form a conductive seal by forming electrically conductive paths intermediate non-conductive sealing medium portions by the application of a compressive load of suitable magnitude. In one example, plate or layer deflection caused by the compressive force causes the plates or layers to make electrical contact in areas where grease is not present. In another example, surface protrusions are provided to ensure electrical contact. In a further example, protrusions and channels are provided to control the amount of grease and contact area between seal surfaces.

In another example, the sealing medium comprises electrically conductive grease.

In another variation, grease enhances seals in multilayered bipolar plates. In a two layer plate, the planar surfaces of the layers have open channels or dive-throughs. When the layers are stacked in contact with each other, the open channels form channels, open or closed, and grease around the channels seals the fluid pathways when the layers are assembled. As described above, layers of suitable designs can be stacked to form open flow channels and elongate angled channels or openings.

In a further variation, sealing surfaces are modified to adjust the surface's capacity to absorb, adsorb or otherwise draw sealing medium into the surface's structure or over or across its surface. Modifications can be made by mechanical or chemical techniques. Exemplary mechanical techniques include engraving, sand blasting and grinding. Exemplary chemical techniques include chemical etching. In one example, the sealing surfaces are patterned. In another example, a priming medium is used to prepare the seal surfaces. In a further aspect, the surfaces are patterned and comprise a priming medium.

In yet another variation, a carrier film is provided which facilitates introduction of the sealing medium into the fluid interface. In one example, the sealing medium is applied to one surface of the carrier film. In another example, the sealing medium is applied to both surfaces of the film. The film is then inserted between the surfaces to be sealed. Exemplary films include polymer films, metal foils, single layer films, multilayered films, laminates and coated films. In one example, the carrier film is shaped with through features to permit passage of fluids and the sealing medium is applied around the through feature.

While this disclosure has been described as having an exemplary design, the invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1-20. (canceled)

21. A fuel cell assembly comprising:
an end plate having an orifice therethrough;
a fuel cell having an active area;
an intermediate plate having an orifice therethrough and a recess, the intermediate plate positioned between the end plate and the fuel cell and positioned such that the recess faces the fuel cell; and
a busplate residing in the recess, the busplate having a planar portion substantially coextensive with the active area and a connecting portion adapted to electrically connect the fuel cell assembly to a load, the connecting portion extending from the planar portion and through the orifices in the intermediate plate and the end plate.

22. A fuel cell assembly as in claim 21 wherein the busplate comprises two L shaped members each having a connecting portion and a planar portion coextensive with the active area, the L-shaped members being arranged to define a T-shaped member.

23. A fuel cell assembly as in claim 21 wherein the busplate is a single piece.

24. A fuel cell assembly as in claim 21 wherein the intermediate plate is a thermal insulator plate.

25. A fuel cell assembly as in claim 21 wherein the busplate has a dielectric layer disposed thereon to prevent the busplate from making electrical contact with the endplate.

26. A fuel cell assembly as in claim 21 wherein the recess is deeper than the thickness of the busplate, and wherein one or more conductive elastic layers are inserted between the busplate and the fuel cell to provide electrical contact and mechanical support.

27. A fuel cell assembly as in claim 21 wherein the busplate is bonded to a conductive fuel cell plate.

28. A fuel cell assembly as in claim 21 further comprising an electrical insulator to prevent electrical contact between the busplate and the endplate.

29. A fuel cell assembly as in claim 28 wherein the electrical insulator is comprised of a plurality of blocks, and wherein the blocks incorporate a through hole through which a fastening member is inserted to secure the busplate to the endplate.

30. A fuel cell assembly comprising:
an end plate having an orifice therethrough and a recess on the inner face of the end plate;
a fuel cell having an active area; and
a busplate residing in the recess, the busplate having a planar portion substantially coextensive with the active area and a connecting portion adapted to electrically connect the fuel cell assembly to a load, the connecting portion extending from the planar portion and through the orifice in the end plate.

31. A fuel cell assembly as in claim 30 wherein the busplate comprises two L shaped members each having a connecting portion and a planar portion coextensive with the active area, the L-shaped members being arranged to define a T-shaped member.

32. A fuel cell assembly as in claim 30 wherein the busplate is a single piece.

33. A fuel cell assembly as in claim 30 wherein the intermediate plate is a thermal insulator plate.

34. A fuel cell assembly as in claim 30 wherein the busplate has a dielectric layer disposed thereon to prevent the busplate from making electrical contact with the endplate.

35. A fuel cell assembly as in claim 30 wherein the recess is deeper than the thickness of the busplate, and wherein one or more conductive elastic layers are inserted between the busplate and the fuel cell to provide electrical contact and mechanical support.

36. A fuel cell assembly as in claim 30 wherein the busplate is bonded to the conductive fuel cell plate.

37. A fuel cell assembly as in claim 30 further comprising an electrical insulator to prevent electrical contact between the busplate and the endplate.

38. A fuel cell assembly as in claim 37 wherein the electrical insulator is comprised of a plurality of blocks, and wherein the blocks incorporate a through hole through which a fastening member is inserted to secure the busplate to the endplate.

39. A fuel cell assembly as in claim 30 wherein the recess comprises one or more frame elements.

40. A fuel cell assembly comprising:
an end plate having an orifice therethrough;
a fuel cell having an active area; and
a busplate having a planar portion substantially coextensive with the active area and a connecting portion adapted to electrically connect the fuel cell assembly to a load, the connecting portion extending from the planar portion and through the orifice in the end plate.
